(19) United States
(12) Patent Application Publication
(10) Pub. No.: US 2008/0050970 A1
(43) Pub. Date: Feb. 28, 2008

(54) CABLE CONNECTOR

(76) Inventor: Che-Chia Chang, Jung-He City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/832,010

(22) Filed: Aug. 1, 2007

(30) Foreign Application Priority Data
Aug. 28, 2006 (CN) 200610037326.7

(51) Int. Cl. H01R 9/03

(52) U.S. Cl. 439/610

(57) ABSTRACT

The present invention provides a cable connector comprising an insulating body; a plurality of conductive contacts arranged in the insulating body along a front to back direction; a cable with a plurality of conductive cores is fixed on the conductive contacts; and a metal shell fastened and surrounded on the outer of the insulating body, the metal shell having a pair of symmetric protrusions with the insulating body along the front to back direction, therefore, excellent fixation and electrical connection are formed between the cable connector and the mating connector.

### BACKGROUND OF THE INVENTION

1. Field of the Invention

The present invention relates to a cable connector, more particularly, relates to a cable connector that used for external electrical equipments.

2. Description of the Related Art

As electronic technology develops, the serial ATA transmission interface are getting to replace the parallel ATA transmission to mainstream market due to use only one serial transmission pair to perform a transmission channel that is needed to high speed data processing and communication in cable connecting system of electronic equipments such as computers, servers etc.

Generally, a traditional cable connector comprises an insulating body and a cable, wherein the cable comprises a plurality of signal lines and ground lines that soldered with each of the conductive contacts and ground contacts of an electrical connector, respectively.

Further, since serial ATA cable connectors are often used to transmit high frequency signals, the requirements of the shielding function to the structure of the connector is quite strict. Therefore, a metal shielding structure should be set between the insulating body and the outer layer of the cable connector.

When a cable connector plugged into a mating connector, it's caused a condition of bad contact due to an interstice exists between the inner wall of the mating connector and the outer metal shielding structure of the cable connector, and to decrease an effective shielding performance therebetween.

In order to achieve the metal shielding structure to fasten steadily a cable for preventing a malposition due to bend between each of transmission lines therein during manufacture, the applicant's US. Pat. No. 6,866,539 and US. Pat. No. 6,913,489 have described that they comprise a metal cover having a positioner for clamping out of a cable. The positioner having a holding wing will be adjusted as the size of the cable. Thus it is complex in designing.

### SUMMARY OF THE INVENTION

The object of the present invention is to provide a cable connector which can be assembled easily with a metal shell having an excellent shielding effect thereof.

The cable connector in accordance with the present invention comprises an insulating body, a plurality of conductive contacts arranged in the insulating body along a front to back direction, a cable including a plurality of conductive cores which are fixed with each of the conductive contacts, and a metal shell fastened and surrounded the outer of the insulating body, wherein the metal shell outwardly forms a pair of symmetric protrusions thereof with the front to back direction vertically. Therefore, excellent fixation and electrical connection are formed between the cable connector and the mating connector.

Wherein, the cable connector further comprises a holding element for holding the cable and the metal shell, and a jacket is covered through the back end of the insulating body, the metal shell and the front end of the cable.

### BRIEF DESCRIPTION OF THE DRAWINGS

FIG. 1 is a perspective view of the cable connector in accordance with the present invention;

FIG. 2 is a perspective view of the cable connector excluding the outer jacket, in accordance with the present invention;

FIG. 3 is a fragmentary exploded perspective view of the cable connector, in accordance with the present invention;

FIG. 4 is a perspective view of the cable connector and a mating connector, in accordance with the present invention;

FIG. 5 is the top view of the plugging between the cable connector and a mating connector, in accordance with the present invention;

FIG. 5A is the A-A line cross sectional view of FIG. 5; and

FIG. 5B is the B-B line cross sectional view of FIG. 5.

### DETAILED DESCRIPTION OF THE PREFERRED EMBODIMENT

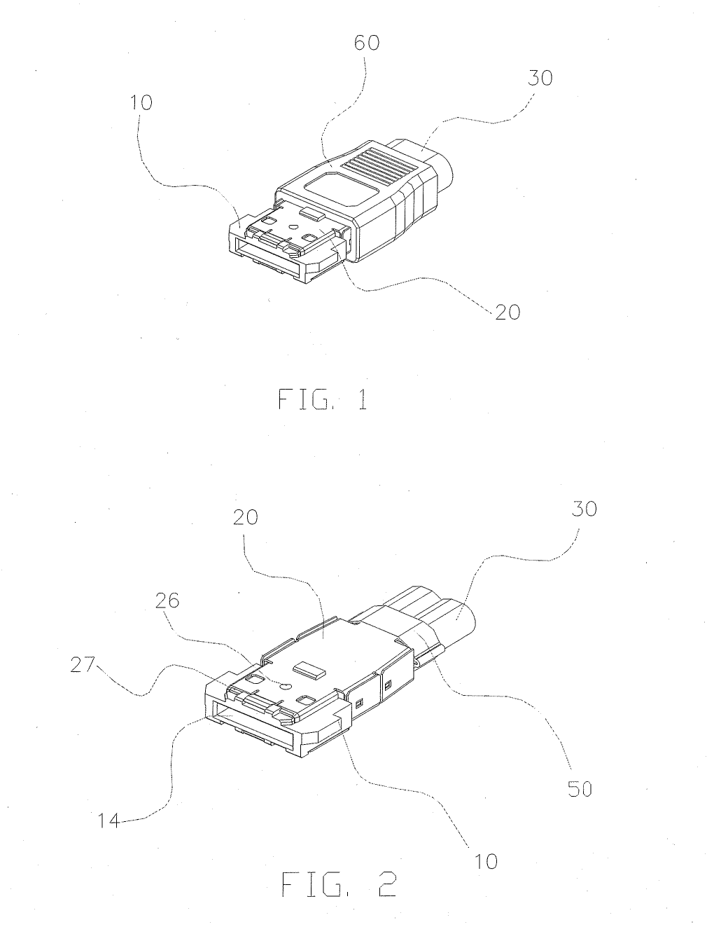

Referring to FIGS. 1, 2, 3 and 4, a preferred embodiment of the present invention is provided. The cable connector of the embodiment is a serial ATA connector that plugged with a mating connector device to provide electrical signal transmission. The cable connector comprises an insulating body 10, a metal shell 20, a cable 30, a plurality of conductive contacts 40, a holding element 50 and a jacket 60.

The insulating body 10 comprises a top wall 11, a bottom wall 12 corresponding to the top wall 11, and two of the side walls 13 adjoined to the top wall 11 and bottom wall 12 respectively, all the walls surrounded and formed a rectangle cavity 14. For easy explanation, the front end of the cavity 14 is defined as an inserting port 10a, and its back end is defined as a cable connection port 10b. Both of the top wall 11 and the bottom wall 12 are formed a bulge 15 respectively. Each bulge 15 has a pair of first protuberances 17 adjoining to the inserting port 10a, and a concave 16 formed between the two first protuberances 17, and a second protuberance 18 formed near the cable connection port 10b thereon.

The metal shell 20 comprises a first shielding case 21 and a second shielding case 22 that can be engaged each other for holding and shielding the insulating body 10 along a front to back direction. Both of the first shielding case 21 and the second shielding case 22 have a tongue slat 23 corresponding to the concave 16 between the two first protuberances 17 respectively, and a perforation 24 is formed corresponding to the second protuberance 18. Further, there is a pair of side walls 25 beside the first shielding case 21 and the second shielding case 22 respectively. Each of side walls 25 have a fasten slot 251 or a fasten piece 252 that opposite between the first shielding case 21 and the second shielding case 22 for engaging each other. In addition, a pair of symmetric protrusions 26 are outwardly formed on the first shielding case 21 and the second shielding case 22 along a front to back direction, and a pair of incline planes 27 are provided on both sides of the bulge 15 of the tongue slat 23 that near the inserting port 10a. Furthermore, the first shielding case 21 and the second shielding case 22 are both provided with an extended portion 28 that parallel extend from the cable connection port 10b.

The cable 30 comprises a plurality of signal transmission units 31, each of units 31 comprises a pair of signal lines 32 and an electrical cover layer 33 covered the signal lines 32 in part, and each signal line 32 is fixed to connect with a conductive contact 40 by soldering or crimping.

The holding element 50 comprises a first positioning clamp 51 and a second positioning clamp 52 for holding the metal shell 20 and the cable 30. Further, the jacket 60 is covered the back end of the insulating body 10, the metal shell 20 and the front end of the cable 30.

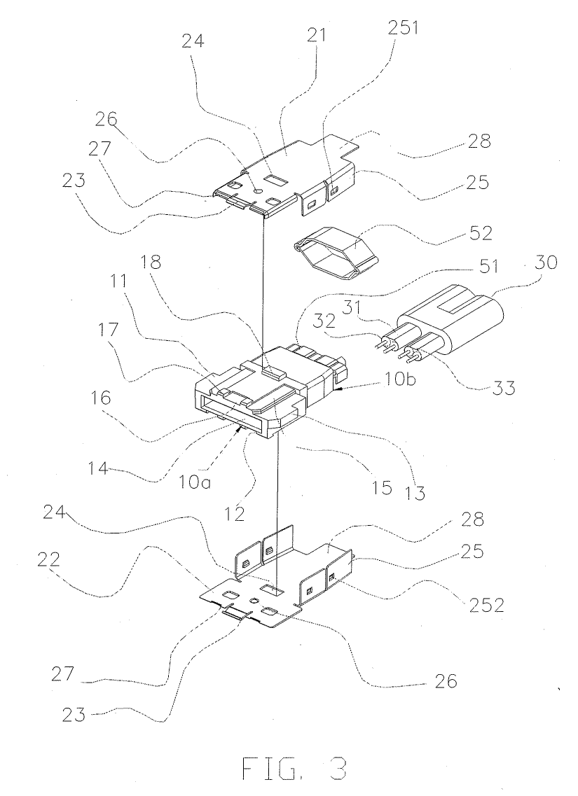

Referring to FIG. 2 to FIG. 3, each conductive contact 40 is contained in the insulating body 10 along a front to back direction. The first shielding case 21 and the second shielding case 22 are held by the fasten slot 251 and fasten piece 252, and the perforation 24 engages the second protuberance 18 to make the first shielding case 21 and the second shielding case 22 for holding at the outside of the insulating body 10 along the front to back direction of the cavity 14. The tongue slat 23 of the first shielding case 21 and the second shielding case 22 are placed in the concave 16 of the top wall 11 and the bottom wall 12 respectively, and the incline planes 27 lie on both sides of the first protuberance 17 of the concave 16.

Further, the signal transmission unit 31 of the cable 30 is held and covered by the first positioning clamp 51, then the second positioning clamp 52 is held and covered the extension section 28 of the first shielding case 21 and the second shielding case 22 for holding the metal shell 20 and the cable 30; and then the jacket 60 covers the back end of the insulating body 10, the metal shell 20 and the front end of the cable 30.

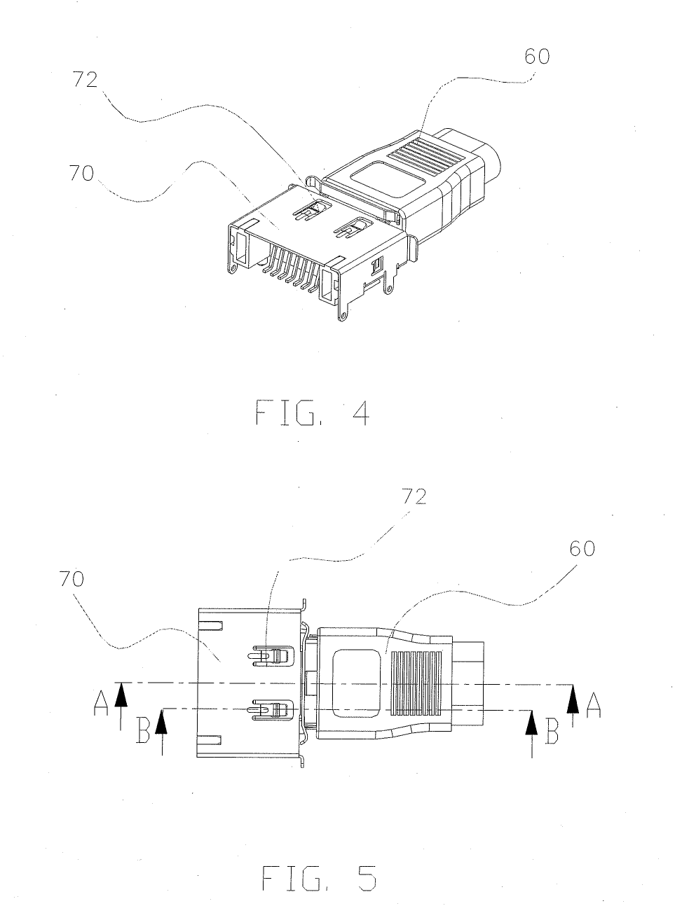

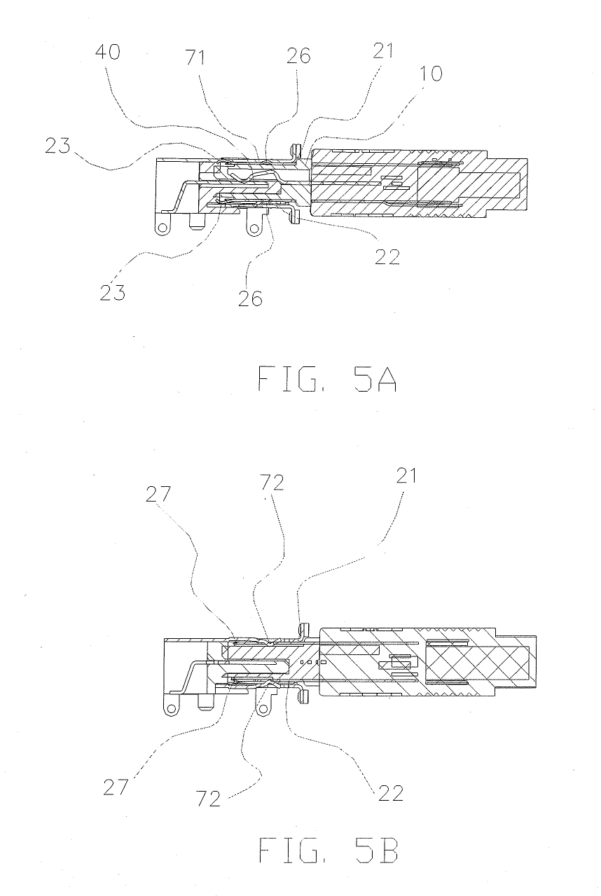

Referring to FIGS. 4 and 5, the plugging between the cable connector and a pair of mating connectors 70 is shown. The mating connectors 70 are fixed on the circuit board (not shown in the figure). During the initial inserting, the tongue slat 23 at the front end of the metal shell 20 contacts with the inner wall 71 of the mating connector 70, thus to form a ground loop due to the effect of electric charge discharge of the cable connector to guide to the chassis ground thereby enhance the quality of communicate quality. Further, the protrusions 26 of the metal shell 20 are provided to increase the contact area with the inner wall 71 of mating connector 70 (as shown in FIG. 5A), thus to achieve excellent fixation and electrical connection between the cable connector and the mating connector. In addition, the inner wall 71 of the mating connector 70 is provided with a fasten elastic piece 72, the elastic piece 72 corresponds to the incline plane 27 lies on both sides of the first protuberance 17 fixed on the concave 16 of the metal shell 20. Therefore, it is easy for the cable connector to pass through the inserting port 10a to insert into the mating connector (as shown in FIG. 5B) without encumbrance.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A cable connector for connecting with a mating connector, said cable connector comprising:
an insulating body having a cavity;
a plurality of conductive contacts arranged in the insulating body along a front to back direction;
a cable having a plurality of signal transmission units, each unit having a pair of signal lines to respectively connect with each of the conductive contacts and a conductive cover layer covered on each of the signal lines in part; and
a metal shell fastened and surrounded the outer of the insulating body, the metal shell having a pair of symmetric protrusions and a tongue slat corresponding to the front end of the mating connector provided.

2. The cable connector according to claim 1, wherein said metal shell comprises a first shielding case and a second shielding case connected to each other with the insulating body vertically along the front to back direction.

3. The cable connector according to claim 2, wherein the side walls of the first shielding case and the second shielding case have at least a fasten slot or at least a fasten piece for engaging each other.

4. The cable connector according to claim 1, wherein said metal shell forms a pair of incline planes at the inserting port.

5. A cable connector for connecting with a mating connector, said cable connector comprising:
an insulating body having a cavity;
a plurality of conductive contacts arranged in the insulating body along a front to back direction;
a cable having a plurality of signal transmission units, each unit having a pair of signal lines to respectively connect with each of the conductive contacts and a conductive cover layer covered on each of the signal lines in part;
a metal shell fastened and surrounded the outer of the insulating body, the metal shell having a pair of symmetric protrusions, and a tongue slat corresponding to the front end of the mating connector provided;
a holding element for holding the position of the cable and the metal shell; and
a jacket covered through the back end of the insulating body, the metal shell and the front end of the cable.

6. The cable connector according to claim 5, wherein said metal shell comprises a first shielding case and a second shielding case connected to each other with the insulating body vertically along the front to back direction.

7. The cable connector according to claim 6, wherein the side walls of the first shielding case and the second shielding case have at least a fasten slot or at least a fasten piece for engaging each other.

8. The cable connector according to claim 5, wherein said metal shell forms a pair of incline planes at the inserting port.
